(19) United States
(12) Patent Application Publication
(10) Pub. No.: US 2006/0184894 A1
(43) Pub. Date: Aug. 17, 2006

(54) Global window management for parent/child relationships

(75) Inventors: Fonda J. Daniels, Cary, NC (US); Paul Franklin McMahan, Apex, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/057,971

(22) Filed: Feb. 15, 2005

(51) Int. Cl. G06F 17/00

(52) U.S. Cl. 715/783; 715/802

(57) ABSTRACT

A mechanism is provided for maintaining some global windowing context to parent/child relationships. When a current window spawns a child window, a data structure stores the parent/child relationship within the window hierarchy. A cascading menu indicates to the user the contextual relationship of a current window to related windows. The user may then navigate among related windows using the cascading menu.

### BACKGROUND OF THE INVENTION

1. Technical Field

The present invention generally relates to computer systems and, more specifically, to a method, apparatus, and program for global window management for parent/child relationships.

2. Description of Related Art

Spawning child windows and navigating through the window hierarchy is quite common in Web applications. As the real estate of a user's display crowds with browser windows, it is common for users to minimize these windows. When windows that have parent/child relationships are minimized, the context and the relationships of those windows are often lost. In searching for a particular window, users typically restore the windows in an ad hoc manner and then select the desired window through a trial-and-error approach.

In other words, even though application windows have understood parent/child relationships, these relationships are useless to an operator trying to locate a window among perhaps a dozen or more open windows. No mechanism exists for navigating among related windows after the windows are spawned.

### BRIEF SUMMARY OF THE INVENTION

The present invention recognizes the disadvantages of the prior art and provides a mechanism for maintaining some global windowing context to parent/child relationships. When a current window spawns a child window, a data structure stores the parent/child relationship within the window hierarchy. A cascading menu indicates to the user the contextual relationship of a current window to related windows. The user may then navigate among related windows using the cascading menu.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in which the present invention may be implemented;

FIG. 3 illustrates an example of a screen of display of an application window in accordance with an exemplary embodiment of the present invention;

FIG. 4 is an example of a screen of display of a plurality of related application windows in accordance with an exemplary embodiment of the present invention;

FIG. 5 depicts an example window hierarchy data structure in accordance with an exemplary embodiment of the present invention;

FIGS. 6A-6C illustrate example screens of display for navigating windows in a hierarchy in accordance with exemplary embodiments of the present invention;

FIG. 6D illustrates an example dialog box that is presented responsive to a user closing a window that has children in accordance with an exemplary embodiment of the present invention; and

FIG. 7 is a flowchart illustrating the operation of an application for managing a window hierarchy in accordance with an exemplary embodiment of the present invention.

### DETAILED DESCRIPTION OF THE INVENTION

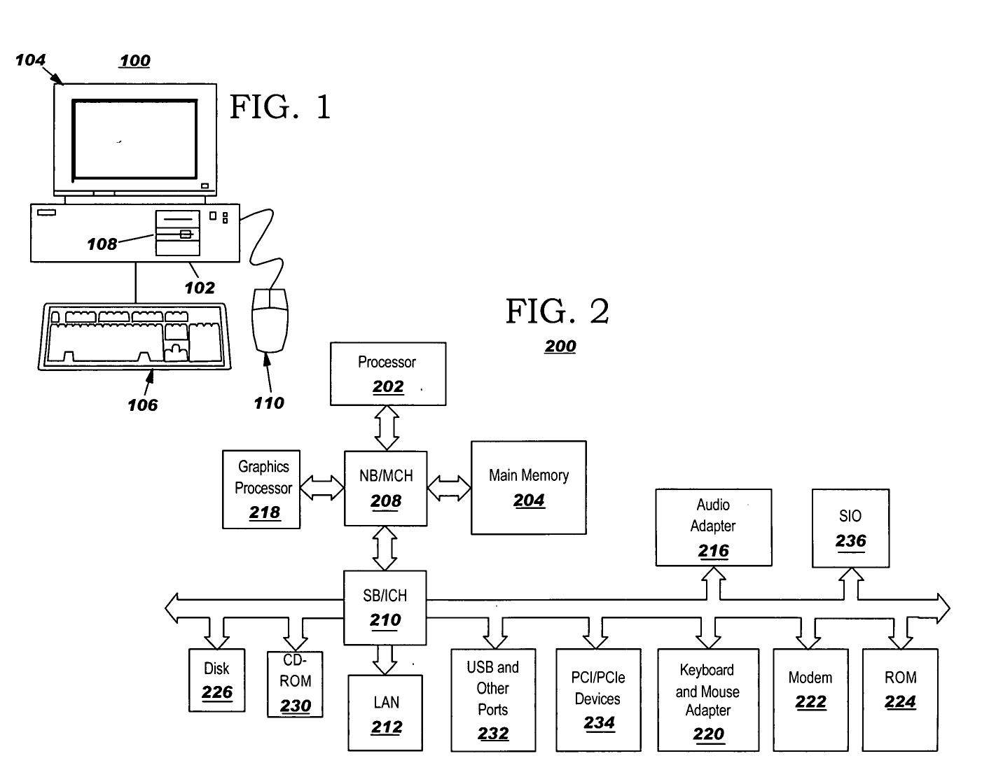

The present invention provides a method, apparatus and computer program product for global window management for parent/child relationships. The data processing device may be a single-processor computing device, a multiprocessing data processing system, or a virtual processor environment in which multiple processors and multiple layers of software may be utilized to perform various aspects of the present invention. Therefore, the following FIGS. 1 and 2 are provided as exemplary diagrams of data processing environments in which the present invention may be implemented. It should be appreciated that FIGS. 1 and 2 are only exemplary and are not intended to assert or imply any limitation with regard to the environments in which the present invention may be implemented. Many modifications to the depicted environments may be made without departing from the spirit and scope of the present invention.

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer™ computer or IntelliStation® computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM driver 230, universal serial bus (USB) ports and other communications ports 232, and PCI/PCIe devices 234 may be connected to ICH 210. PCI/PCIe devices may include, for example, Ethernet adapters, add-in cards, PC cards for notebook computers, etc. PCI uses a cardbus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to ICH 210.

An operating system runs on processor 202 and is used to coordinate and provide control of various components within data processing system 200 in FIG. 2. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 200. “JAVA” is a trademark of Sun Microsystems, Inc. Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, memory 224, or in one or more peripheral devices 226 and 230.

Those of ordinary skill in the art will appreciate that the hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. Also, the processes of the present invention may be applied to a multiprocessor data processing system.

For example, data processing system 200 may be a personal digital assistant (PDA), which is configured with flash memory to provide non-volatile memory for storing operating system files and/or user-generated data. The depicted example in FIG. 2 and above-described examples are not meant to imply architectural limitations. For example, data processing system 200 also may be a tablet computer, laptop computer, or telephone device in addition to taking the form of a PDA.

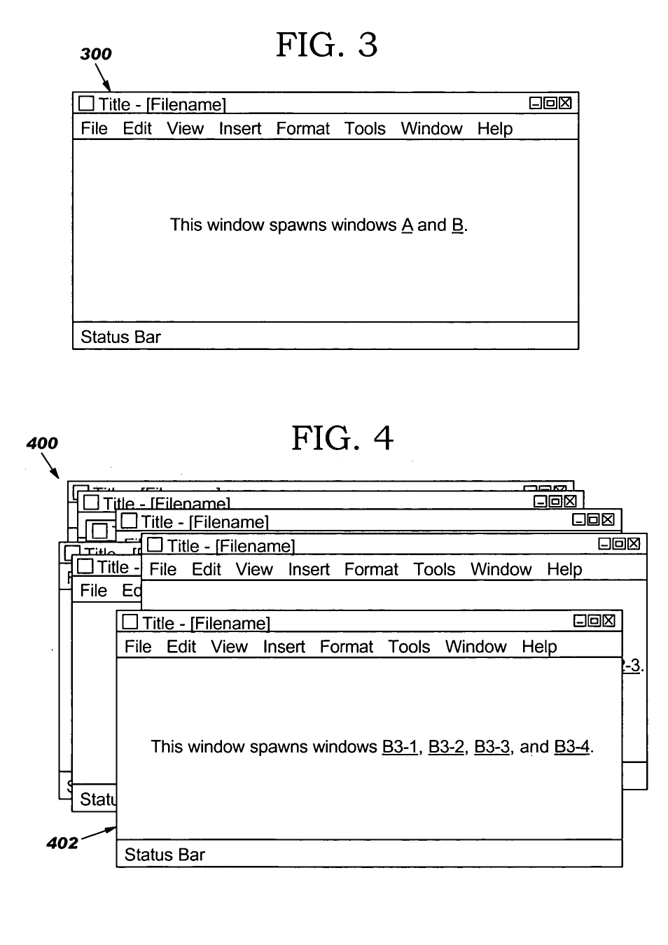

An example of a screen of display of an application window is shown in FIG. 3 in accordance with an exemplary embodiment of the present invention. The screen comprises window 300. Window 300 may be an application window for a Web browser or the like. In the depicted example, window 300 is referred to as the “main” window and may generate child windows A and B.

FIG. 4 is an example of a screen of display of a plurality of related application windows in accordance with an exemplary embodiment of the present invention. Windows 400 may include, for example, main window 300 in FIG. 3, and other windows generated or “spawned” from existing windows. For example, the main window may spawn windows A and B, which are referred to as “child” windows of the main window. Conversely, the main window is referred to as the “parent” of windows A and B. Similarly, window A may spawn windows A1 and A2, window B may spawn windows B1, B2, and B3, and so forth.

Window 402, which may be window B3 in this example, is said to have “focus,” meaning window 402 is on top and receives user input. If a user wishes to navigate from window 402 to another window within windows 400, the user may click on each window, giving each selected window focus, until the desired window is found. However, this trial-and-error approach is inconvenient and becomes unwieldy as the number of windows increases.

In accordance with an exemplary embodiment of the present invention, a data structure stores parent/child relationship information for a plurality of windows in a hierarchy. When a window spawns a child window, the parent/child relationship is recorded. In one exemplary embodiment, one data structure may include all parent/child relationship information for the entire window hierarchy. This data structure may be associated with one window in the hierarchy, such as the highest window in the hierarchy or the window with focus, for example. Alternatively, the data structure may be associated with each window in the hierarchy and updated in each instance when a new window is spawned or when a window is closed. In an alternative embodiment, the data structure is distributed among the windows in the hierarchy, where each window identifies its parent window and its child windows.

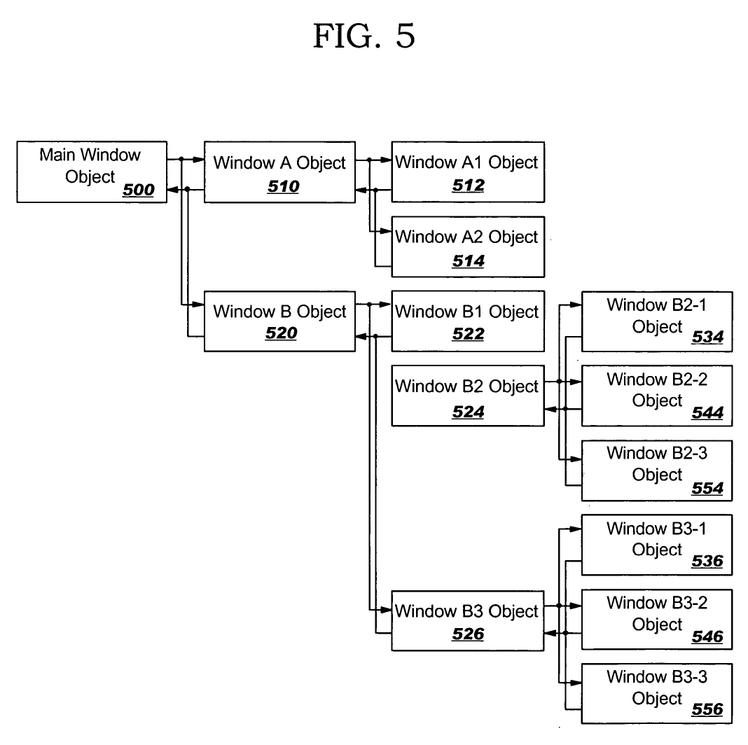

FIG. 5 depicts an example window hierarchy data structure in accordance with an exemplary embodiment of the present invention. Main window object 500 represents the main window, which is the highest window in the hierarchy. The main window spawns window A and window B. Main window object 500 references window A object 510 and window B object 520 as child windows. In turn, window A object 510 and window B object 520 reference main window object 500 as their parent window.

Window A spawns window A1 and window A2. Window A object 510 references window A1 object 512 and window A2 object 514 as child windows. In turn, window A1 object 512 and window A2 object 514 reference window A object 510 as their parent window.

Similarly, window B spawns window B1, window B2, and window B3. Window B object 520 references window B1 object 522, window B2 object 524, and window B3 object 526 as child windows. In turn, window B1 object 522, window B2 object 524, and window B3 object 526 reference window B object 520 as their parent window.

Furthermore, window B2 spawns window B2-1, window B2-2, and window B2-3. Window B2 object 524 references window B2-1 object 534, window B2-2 object 544, and window B2-3 object 554 as child windows. In turn, window B2-1 object 534, window B2-2 object 544, and window B2-3 object 554 reference window B2 object 524 as their parent window. Window B3 spawns window B3-1, window B3-2, and window B3-3. Window B3 object 526 references window B3-1 object 536, window B3-2 object 546, and window B3-3 object 556 as child windows. In turn, window B3-1 object 536, window B3-2 object 546, and window B3-3 object 556 reference window B3 object 526 as their parent window.

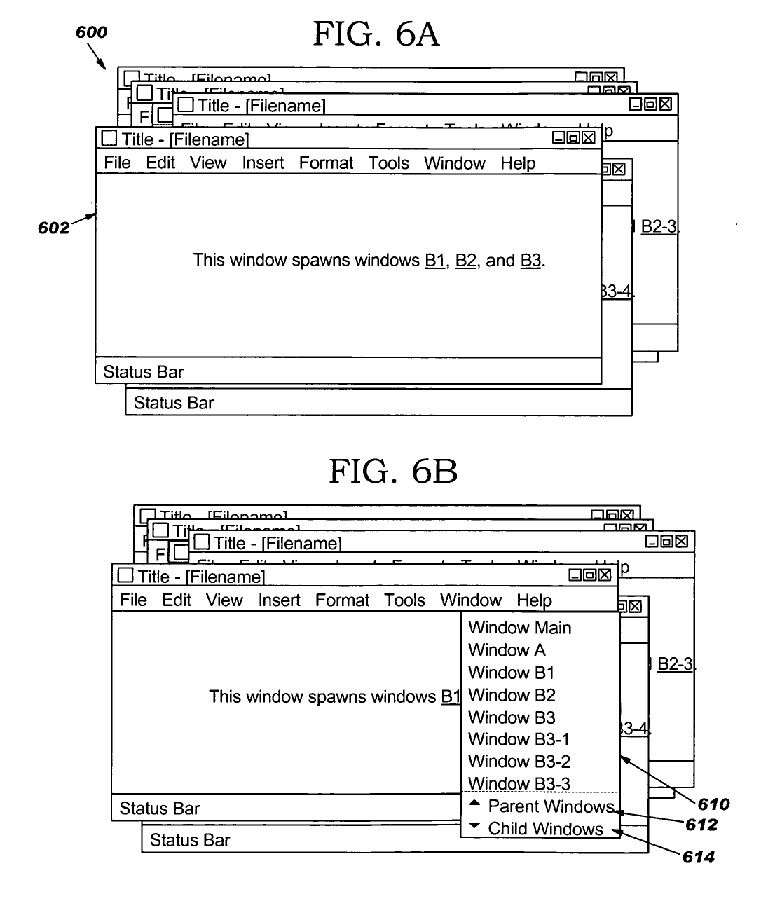

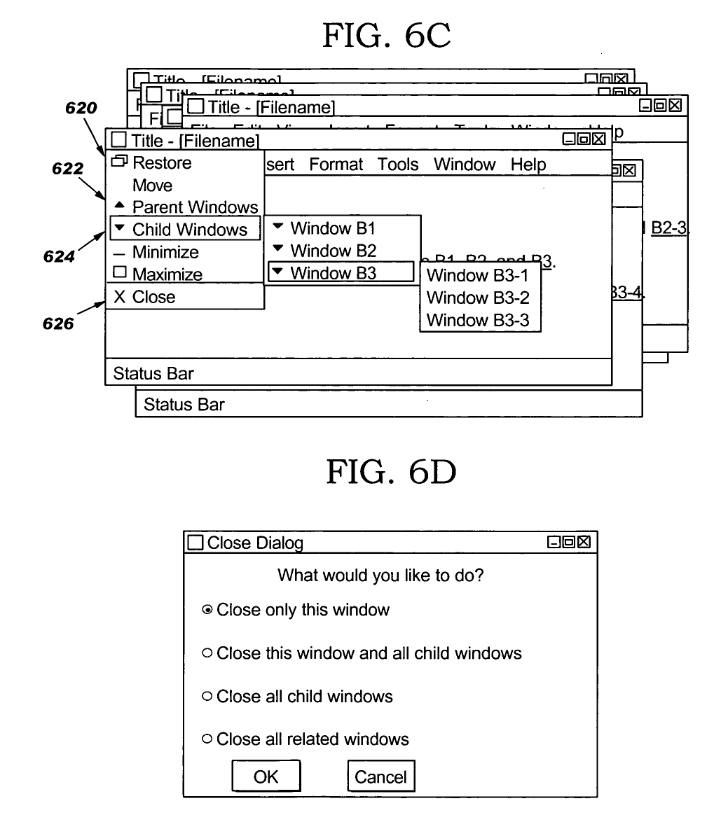

FIGS. 6A-6C illustrate example screens of display for navigating windows in a hierarchy in accordance with exemplary embodiments of the present invention. More particularly, with reference to FIG. 6A, windows 600 may include windows that are related in a hierarchy. Window 602, which may be window B in the above example, is said to have “focus,” meaning window 602 is on top and receives user input.

With reference now to FIG. 6B, cascading menu 610 is generated. In the depicted example, cascading menu 610 is part of the “Windows” menu in the menu bar. Cascading menu 610 includes “Parent Windows” option 612 and “Child Windows” option 614. A user may then navigate to the parent window by selecting “Parent Windows” option 612. Since menu 610 is cascading, the “Parent Windows” option may cascade to another menu to allow the user to select the parent of the parent. Alternatively, since each window will have only one parent, the parent windows may be presented as a list from the parent of the current window back to the root of the hierarchy.

A user may navigate to child windows by selecting “Child Windows” option 614. If a window has multiple child windows, then option 614 will result in a menu of child windows. Since the menu is cascading, each child window in the menu may have a submenu of child windows.

Turning to FIG. 6C, cascading menu 620 is generated. In the depicted example, cascading menu 620 is part of the control box menu that is generated when the control box in the upper left corner of the tile bar is selected. Cascading menu 620 includes “Parent Windows” option 622 and “Child Windows” option 624. A user may then navigate to the parent window by selecting “Parent Windows” option 622. Since menu 620 is cascading, the “Parent Windows” option may cascade to another menu to allow the user to select the parent of the parent.

A user may navigate to child windows by selecting “Child Windows” option 624. If a window has multiple child windows, then option 624 will result in a menu of child windows. In the illustrated example, a user selects the “Child Windows” option by, for example, holding a mouse cursor over the option, selecting a graphical control next to the option, depressing a predetermined key sequence, or the like. Responsive to the user selecting the “Child Windows” option, a menu of child windows is generated including “Window B1,” “Window B2,” and “Window B3.” Since the menu is cascading, each child window in the menu may have a submenu of child windows, such as the submenu including “Window B3-1,” “Window B3-2,” and “Window B3-3.”

Menu 620 may also include “Close” control 626. The close control may be selected to close the current window. However, since the current window may have a parent window and/or child windows, closing the current window may affect the window hierarchy. If a window with children is closed, then each child becomes the main window for its own hierarchy.

In accordance with an exemplary embodiment of the present invention, selecting a close control, such as control 626 in FIG. 6C, generates a dialog box. FIG. 6D illustrates an example dialog box that is presented responsive to a user closing a window that has children in accordance with an exemplary embodiment of the present invention. The dialog prompts the user to close only the current window, close the current window and all child windows, close only the child windows, or close all windows in the hierarchy.

This may be particularly useful with a Web browser application, where pop-up advertisements may be spawned in child windows. A user may not realize that child windows even exist. Therefore, the user may decide to close a current window and all child windows while leaving other windows in the hierarchy open and active. Alternatively, the user may wish to keep the current window active, but close all child windows.

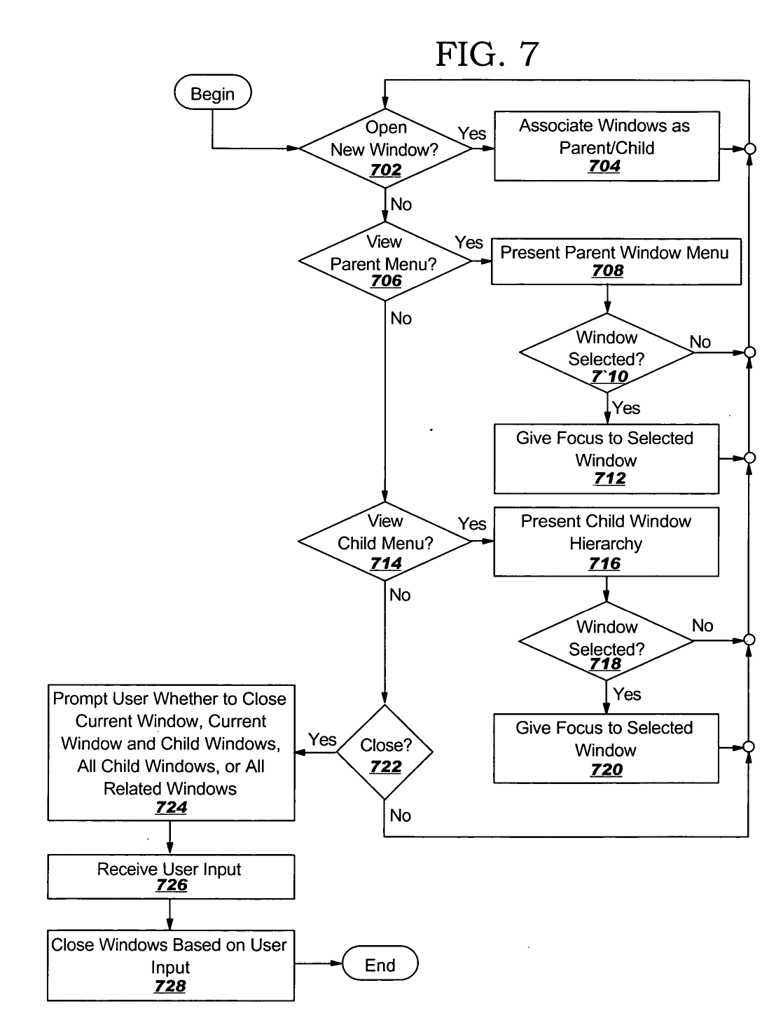

FIG. 7 is a flowchart illustrating the operation of an application for managing a window hierarchy in accordance with an exemplary embodiment of the present invention. Operation begins and a determination is made as to whether a user performs an action that results in a new window being generated (block 702). If a new window is to be spawned, the application associates the current window and the newly spawned window as having a parent/child relationship in a data structure (block 704). Thereafter, operation returns to block 702 to determine whether a new window is to be generated.

If a user does not perform an action that results in a new window being generated in block 702, a determination is made as to whether the user selects a parent menu option to display a menu of parent windows (block 706). If a menu of parent windows is to be presented, the application presents the parent window menu (block 708) and a determination is made as to whether a window is selected from the parent window menu (block 710). If a window is not selected, operation returns to block 702 to determine whether a new window is to be generated. If a window is selected in block 710, focus is given to the selected window (block 712) and operation returns to block 702 to determine whether a new window is to be generated.

If the user does not select a parent menu option to display a menu of parent windows in block 706, then a determination is made as to whether the user select a child menu option to display a menu of child windows (block 714). If a menu of child windows is to be presented, the application presents the child window menu (block 716). The child menu may be presented as a hierarchy of cascading menus as described above with reference to FIGS. 6B and 6C. Next, a determination is made as to whether a window is selected from the child window menu (block 718). If a window is not selected, operation returns to block 702 to determine whether a new window is to be generated. If a window is selected in block 718, focus is given to the selected window (block 720) and operation returns to block 702 to determine whether a new window is to be generated.

If the user does not select a child menu option in block 714, a determination is made as to whether a user performs an action that would result in the current window closing (block 722), such as selecting a close control or menu option. If the user does not perform an action that would result in the current window closing, then operation returns to block 702 to determine whether a new window is to be generated.

If the user does perform an action that would result in the current window closing in block 722, the application prompts the user whether to close the current window, close the current window and all child windows, close all child windows, or close all related windows (block 724). Then, the application receives user input (block 726) and closes windows based on the user input (block 728). If the user closes only the current window, then each child window becomes the root window in its own hierarchy. Otherwise, the window is updated accordingly. Thereafter, operation ends.

Thus, the present invention solves the disadvantages of the prior art by providing a mechanism for maintaining some global windowing context to parent/child relationships. When a current window spawns a child window, a data structure stores the parent/child relationship within the window hierarchy. A cascading menu indicates to the user the contextual relationship of a current window to related windows. The user may then navigate among related windows using the cascading menu.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for managing a hierarchy of related windows, the method comprising:
associating a current window with a first set of child windows, wherein the current window has a parent/child relationship with each window in the first set of child windows; and
responsive to selection of a child menu control, presenting a child window menu within the current window, wherein the child window menu lists the first set of child windows.

2. The method of claim 1, further comprising:
responsive to selection of a child window in the child window menu, displaying the selected child window as the current window.

3. The method of claim 1, wherein a given child window within the first set of child windows has associated therewith a second set of child windows, wherein the given child window has a parent/child relationship with each window in the second set of child windows, the method further comprising:
responsive to selection of a child submenu control, presenting a child window submenu in association with the child window menu, wherein the child window submenu lists the second set of child windows.

4. The method of claim 3, further comprising:
responsive to selection of a child window within the child window submenu, displaying the selected child window as the current window.

5. The method of claim 1, further comprising:
associating the current window with a first parent window, wherein the current window is a child of the first parent window in the first set of child windows; and
responsive to selection of a parent menu control, presenting a parent window menu within the current window, wherein the parent window menu lists the first parent window.

6. The method of claim 5, further comprising:
responsive to selection of the first parent window in the parent window menu, displaying the selected first parent window as the current window.

7. The method of claim 1, wherein the first parent window has associated therewith a second parent window, wherein the first parent window is a child of the second parent window, the method further comprising:
responsive to selection of a parent submenu control, presenting a parent window submenu in association with the parent window menu, wherein the parent window submenu lists the second parent window.

8. The method of claim 7, further comprising:
responsive to selection of the second parent window in the parent window submenu, displaying the selected parent window as the current window.

9. The method of claim 1, further comprising:
responsive to activation of a close window control, performing one of closing only the current window, closing the current window and all child windows, closing all child windows, and closing all windows in the hierarchy of related windows.

10. The method of claim 9, further comprising:
responsive to closing only the current window, creating a new hierarchy of related windows for each window that is a child of the current window.

11. A computer program product, in a computer readable medium, for managing a hierarchy of related windows, the computer program product comprising:
instructions for associating a current window with a first set of child windows, wherein the current window has a parent/child relationship with each window in the first set of child windows; and
instructions, responsive to selection of a child menu control, for presenting a child window menu within the current window, wherein the child window menu lists the first set of child windows.

12. The computer program product of claim 11, further comprising:
instructions, responsive to selection of a child window in the child window menu, for displaying the selected child window as the current window.

13. The computer program product of claim 11, wherein a given child window within the first set of child windows has associated therewith a second set of child windows, wherein the given child window has a parent/child relationship with each window in the second set of child windows, the computer program product further comprising:
instructions, responsive to selection of a child submenu control, for presenting a child window submenu in association with the child window menu, wherein the child window submenu lists the second set of child windows.

14. The computer program product of claim 11, further comprising:
instructions for associating the current window with a first parent window, wherein the current window is a child of the first parent window in the first set of child windows; and
instructions, responsive to selection of a parent menu control, for presenting a parent window menu within the current window, wherein the parent window menu lists the first parent window.

15. The computer program product of claim 14, further comprising:
instructions, responsive to selection of the first parent window in the parent window menu, for displaying the selected first parent window as the current window.

16. The computer program product of claim 11, further comprising:
instructions, responsive to activation of a close window control, for performing one of closing only the current window, closing the current window and all child windows, closing all child windows, and closing all windows in the hierarchy of related windows.

17. The computer program product of claim 16, further comprising:
instructions, responsive to closing only the current window, for creating a new hierarchy of related windows for each window that is a child of the current window.

18. An apparatus, in a data processing system, for managing a hierarchy of related windows, the apparatus comprising:
means for associating a current window with a first set of child windows, wherein the current window has a parent/child relationship with each window in the first set of child windows; and
means, responsive to selection of a child menu control, for presenting a child window menu within the current window, wherein the child window menu lists the first set of child windows.

19. The apparatus of claim 18, further comprising:
means, responsive to selection of a child window in the child window menu, for displaying the selected child window as the current window.

20. The apparatus of claim 18, wherein a given child window within the first set of child windows has associated therewith a second set of child windows, wherein the given child window has a parent/child relationship with each window in the second set of child windows, the apparatus further comprising:
means, responsive to selection of a child submenu control, for presenting a child window submenu in association with the child window menu, wherein the child window submenu lists the second set of child windows.
